(19) United States
(12) Patent Application Publication
(10) Pub. No.: US 2018/0178129 A1
(43) Pub. Date: Jun. 28, 2018

(54) RECORDING MEDIUM STORING GAME PROCESSING PROGRAM AND DATA PROCESSING APPARATUS

(71) Applicant: KOEI TECMO GAMES CO., LTD., KANAGAWA (JP)

(72) Inventors: Fumiya KATO, KANAGAWA (JP); Kohei KUMAZAKI, KANAGAWA (JP)

(21) Appl. No.: 15/787,914

(22) Filed: Oct. 19, 2017

(30) Foreign Application Priority Data
Dec. 27, 2016 (JP) 2016-252887
Sep. 21, 2017 (JP) 2017-180995

(51) Int. Cl. A63F 13/655; A63F 13/95; A63F 13/25; A63F 13/214

(52) U.S. Cl. CPC A63F 13/655; A63F 13/95; H04N 5/33; A63F 13/214; A63F 13/25

(57) ABSTRACT

A non-transitory computer-readable recording medium having recorded thereon a game processing program that causes a computer to execute a process includes: photographing an object using an infrared sensor; and specifying a parameter regarding a game based on at least either of a shape and brightness of the photographed object, by referring to a storage unit in which at least either of a plurality of shapes of an object and a plurality of brightness's are in association with parameters regarding the game, respectively.

### CROSS-REFERENCE TO RELATED APPLICATION

The present application is based on and claims the benefit of priority of Japanese Priority Application No. 2016-252887 filed on Dec. 27, 2016, and Japanese Priority Application No. 2017-180995 filed on Sep. 21, 2017, the entire contents of which are hereby incorporated by reference.

### BACKGROUND OF THE INVENTION

### 1. Field of the Invention

The present invention relates to a recoding medium storing a game processing program and a data processing apparatus.

### 2. Description of the Related Art

A game device capable of displaying an image of a game on a display, and enabling a player to play the game by operating operation buttons is known (see Patent Document 1, for example). Further, a technique of a game by which a hand gesture or a QR (Quick Response) code (registered trademark) is photographed, and a game is processed using the photographed gesture or the code is also known (see Patent Documents 2 and 3, for example).

However, according to the above described technique, one game process is performed for one gesture. Further, one game process is performed for one QR code (registered trademark). In other words, one process is performed for one object.

### Patent Documents

[Patent Document 1] U.S. published application No. 2016/0361640

### [Patent Document 2] Japanese Laid-open Patent Publication No. 2016-57779

### [Patent Document 3] Japanese Laid-open Patent Publication No. 2012-176115

### SUMMARY OF THE INVENTION

The present invention is made in light of the above problems, and provides a technique enabling a user to select a preferable one from a plurality of different selections using one object.

According to an embodiment, there is provided a non-transitory computer-readable recording medium having recorded thereon a game processing program that causes a computer to execute a process including: photographing an object using an infrared sensor; and specifying a parameter regarding a game based on at least either of a shape and brightness of the photographed object, by referring to a storage unit in which at least either of a plurality of shapes of an object and a plurality of brightness's are in association with parameters regarding the game, respectively.

### BRIEF DESCRIPTION OF THE DRAWINGS

Other objects, features and advantages of the present invention will become more apparent from the following detailed description when read in conjunction with the accompanying drawings.

FIG. 1A and FIG. 1B are views for describing an example of a game device of an embodiment;

FIG. 2 is a view illustrating an example of a hardware structure of the game device of the embodiment;

FIG. 3 is a view illustrating an example of a functional structure of the game device of the embodiment;

FIG. 4 is a view illustrating an example of a parameter table of the embodiment;

FIG. 5A is a view illustrating a state in which an infrared camera is directed to an object;

FIG. 5B is a view illustrating an example of a display of the embodiment in which a parameter is displayed;

FIG. 6 is a flowchart illustrating an example of a game process of the embodiment;

FIG. 7A and FIG. 7B are views respectively illustrating an example of generation of a character in the game process of the embodiment;

FIG. 8 is a view illustrating another example of the parameter table of the embodiment;

FIG. 9 is a view illustrating another example of a display of the embodiment in which a parameter is displayed;

FIG. 10 is a flowchart illustrating a game process of an applied example 1 of the embodiment;

FIG. 11 is a view illustrating an example of a scene in a game of the applied example 1 of the embodiment;

FIG. 12 is a view illustrating another example of a scene in a game of the applied example 1 of the embodiment;

FIG. 13 is a flowchart illustrating a game process of an applied example 2 of the embodiment;

FIG. 14 is a view illustrating a scene in which an infrared camera is directed to an object and an example of a display of the applied example 2 of the embodiment;

FIG. 15 is a flowchart illustrating a game process of an applied example 3 of the embodiment; and

FIG. 16 is a view illustrating an example of a display of the applied example 3 of the embodiment.

### DETAILED DESCRIPTION OF THE PREFERRED EMBODIMENTS

The invention will be described herein with reference to illustrative embodiments. Those skilled in the art will recognize that many alternative embodiments can be accomplished using the teachings of the present invention and that the invention is not limited to the embodiments illustrated for explanatory purposes.

It is to be noted that, in the explanation of the drawings, the same components are given the same reference numerals, and explanations are not repeated.

### Game Device

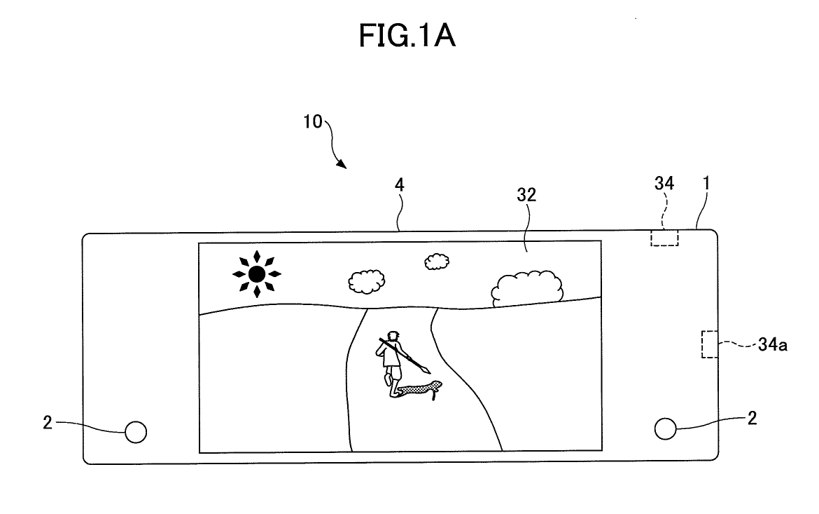

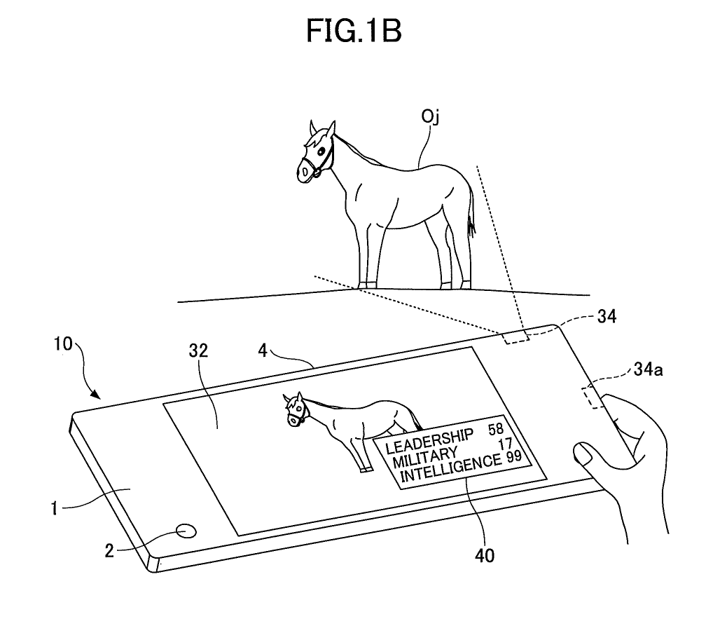

First, an example of a game device 10 of the embodiment is described with reference to FIG. 1A and FIG. 1B. As illustrated in FIG. 1A, the game device 10 includes a main body 4 that functions as a controller (game controller) 1 as well. The main body 4 has a rectangular shape, and has a size capable of being held by one hand or both hands of a user (player). The main body 4 includes a display 32. As the display 32, for example, a liquid crystal display or an organic EL display may be used.

The controller 1 includes a plurality of operation buttons 2 that are positioned at a lower side, and an infrared camera 34 that is positioned at an upper side. The controller 1 further includes a shutter button 34a. The user can play a game that is displayed on the display 32 by operating the operation buttons 2.

As illustrated in FIG. 1B, the user can direct (or point) the infrared camera 34 to an object OJ, and the infrared camera 34 irradiates an infrared ray to the object OJ at a predetermined angle and at a predetermined position. The controller 1 is configured to send an image of the object OJ formed by an infrared ray reflected by the object OJ to the main body 4.

Upon receiving the image of the object OJ, a CPU of the main body 4 analyzes the image of the object OJ. In this embodiment, as will be described later in detail, a parameter regarding the game is specified based on at least either of a shape and brightness of the photographed object OJ. At this time, a shape or brightness specified by analyzing the image of the photographed object OJ differs depending on a photographing position or a photographing direction (photographing angle) of the object OJ. Thus, even when the same object OJ is photographed, different parameters are specified based on the shape or the brightness of the object OJ included in the image of the object OJ depending on the photographing position or the photographing direction of the object OJ. As such, when a specific parameter is extracted based on the shape or the brightness of the object OJ photographed by the infrared camera 34, the specified parameter 40 is displayed on the display 32 as illustrated in FIG. 1B. Further, when the user changes the photographing position or the photographing direction of the object OJ by moving the infrared camera 34, in accordance with this, the specified parameter is also changed, and the changed parameter is displayed on the display 32.

Here, the game device 10 of the embodiment is an example of a data processing apparatus that performs a game based on a downloaded game processing program and game data. The game device 10 may be a personal computer, a tablet computer, a smartphone or the like.

Alternatively, the controller 1 may be provided separately from the main body 4. In such a case, the game device 10 of the embodiment may include two or more controllers 1. As long as the game device 10 includes the display 32, the infrared camera 34 and the operation buttons 2, the controller 1 may be detachably attached to the main body 4.

### Hardware Structure of Game Device

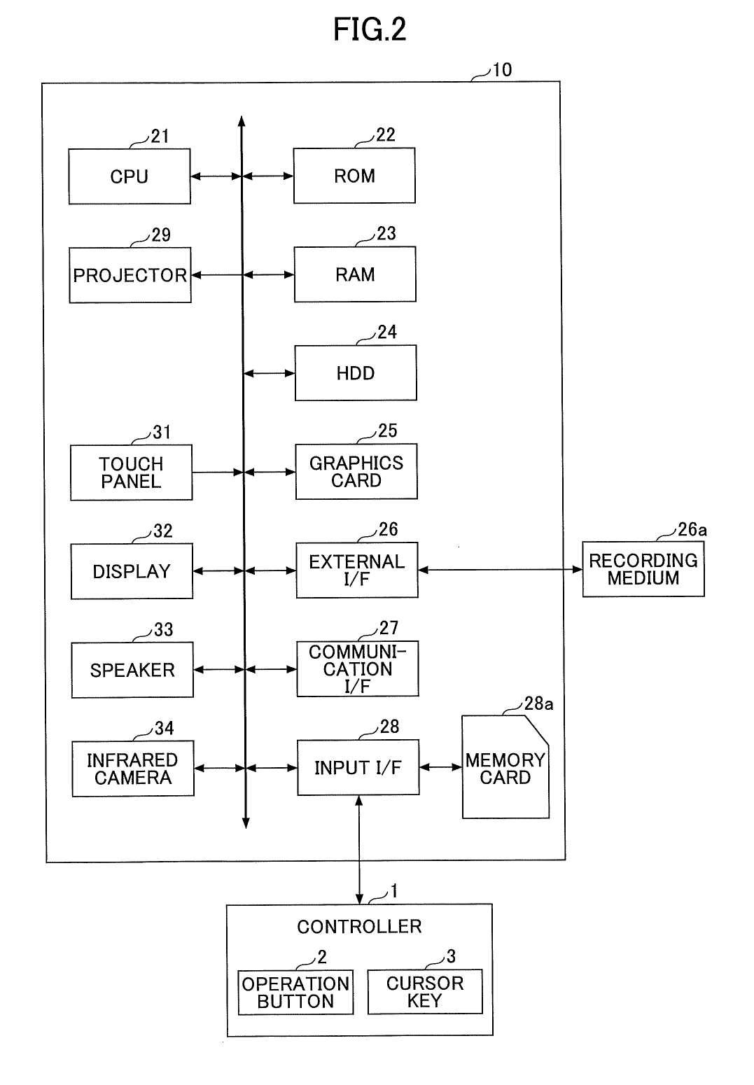

Next, an example of a hardware structure of the game device 10 is described with reference to FIG. 2. The game device 10 of the embodiment includes a Central Processing Unit (CPU) 21, a Read Only Memory (ROM) 22, a Random Access Memory (RAM) 23 and a Hard Disk Drive (HDD) 24.

Further, the game device 10 includes a graphics card 25, an external I/F 26, a communication I/F 27, an input I/F 28, a projector 29, a touch panel 31, a display 32, a speaker 33 and an infrared camera 34. These components are connected with each other by a bus.

The ROM 22 is a nonvolatile semiconductor memory capable of storing internal data even when power is not supplied. The RAM 23 is a volatile semiconductor memory that temporarily stores programs or data. Programs or data are stored in the ROM 22 and the RAM 23.

The HDD 24 is a nonvolatile memory device that stores programs or data. Programs of basic software that controls the entirety of the game device 10 and application software may be stored in the HDD 24. Various databases may be stored in the HDD 24. In this embodiment, various programs and data such as a basic processing program, a game processing program and the like are stored in the HDD 24.

The CPU 21 actualizes control of the entirety of the game device 10 and functions of the game device 10 by reading out the various programs and data from the ROM 22 or the HDD 24 on the RAM 23 and performing various processes.

The external I/F 26 is an interface that connects the game device 10 to an external device. As the external device, a recording medium 26a or the like may be exemplified. With this, the game device 10 is capable of reading out data from and writing data on the recording medium 26a via the external I/F 26. As an example of the recording medium 26a, a Compact Disk (CD), a Digital Versatile Disk (DVD), an SD memory card, a Universal Serial Bus (USB) memory or the like may be exemplified.

For example, it is possible to mount the recording medium 26a storing the game processing program or the like on the game device 10. Such a program is read out by the external I/F 26 and read on the RAM 23.

The CPU 21 executes the game processing program loaded on the RAM 23 and instructs the graphics card 25 to output an image corresponding to the procession of the game. The graphics card 25 performs an imaging process for a game image to be displayed in a screen in accordance with the instruction, and causes the display 32 to display the game image. One frame time of an image output from the graphics card 25 is 1/30 to 1/60 seconds, for example. The graphics card 25 renders a single image by a frame unit. In other words, images of 30 to 60 frames are rendered each second.

Further, the CPU 21 executes the various programs loaded on the RAM 23, and causes the speaker 33 to output a predetermined sound corresponding to the progression of the game. The communication I/F 27 is an interface that connects the game device 10 to a network. The communication I/F 27 communicates with another device via a communication unit including an antenna.

The input I/F 28 is an interface to be connected to an input device such as the controller 1. As described above, the controller 1 includes the operation buttons 2. A user performs a game operation using the controller 1. For example, the user can control a player character PC to perform a predetermined motion by operating the operation buttons 2. The controller 1 may further include a cursor key 3, and the user may move a player character PC in a predetermined direction by operating the cursor key 3.

The input I/F 28 stores input information based on an input operation performed by the user using the controller 1 in the RAM 23. Further, when the user instructs to start a game by operating the controller 1, the game process is started when the input I/F 28 inputs the instruction information.

The infrared camera 34 includes a lens and light receiving elements that sensitize light (infrared ray or near infrared ray). The infrared camera 34 includes an image sensor in which the light receiving elements that sense an infrared ray are vertically and horizontally aligned. Then, when each of the light receiving elements of the image sensor receives an infrared ray output from the infrared camera 34 and reflected by an object (the object OJ, for example), and converts it to an electrical signal, a two-dimensional infrared image is output. The infrared camera 34 is an example of an infrared sensor that photographs an object.

The projector 29 includes a light source that ejects visible light, and projects a character, an image or the like on a projection surface using the light from the light source. The touch panel 31 is provided on a screen of the display 32, and detects a position on the screen touched by the user. Any selectable touch panels, such as a capacitance touch panel or a resistive touch panel, for example, may be used as the touch panel 31.

In the game device 10 having such a structure, when the CPU 21 executes various processes regarding the game, upon instruction from the CPU 21, the input I/F 28 stores data regarding the game stored in the RAM 23 in the memory card 28a. Further, the input I/F 28 reads out data regarding the game that is temporarily paused stored in the memory card 28a and transfers it to the RAM 23.

Here, in this embodiment, it is configured that the functions such as the infrared camera 34 or the touch panel 31 cannot be used when the game device 10 is set as a stationary game device. However, alternatively, it can be configured that the functions such as the infrared camera 34 or the touch panel 31 can be used even when the game device 10 is set as a stationary game device.

### Functional Structure of Game Device

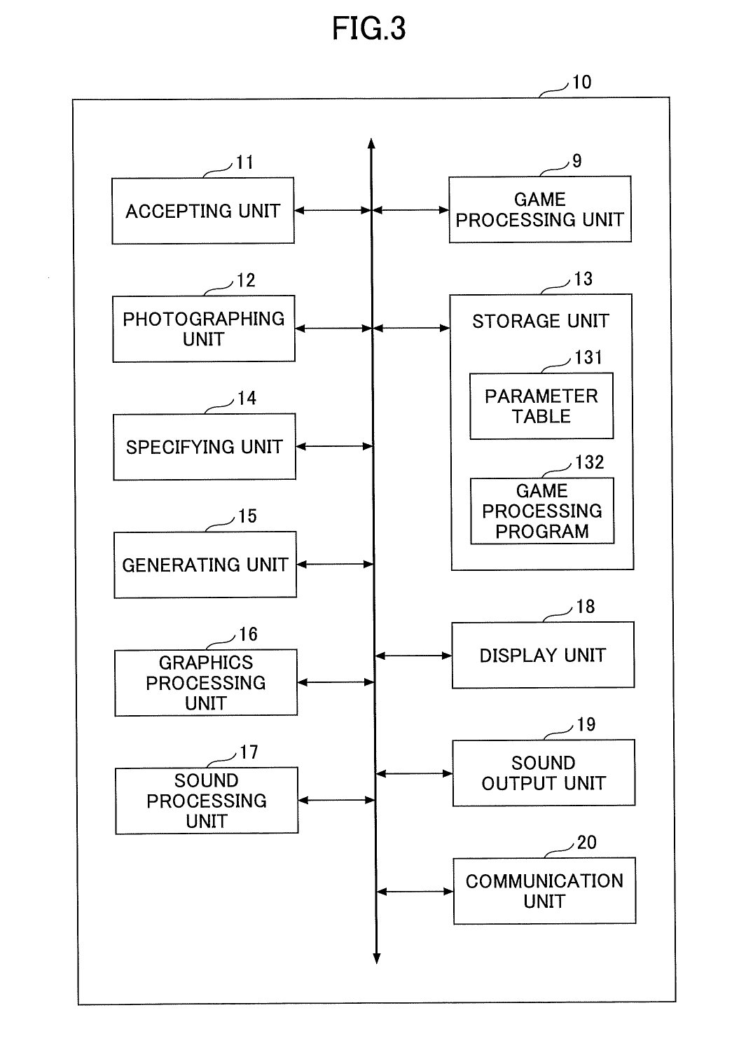

Next, an example of a functional structure of the game device 10 of the embodiment is described with reference to FIG. 3. The game device 10 includes a game processing unit 9, an accepting unit 11, a photographing unit 12, a storage unit 13, a specifying unit 14, a generating unit 15, a graphics processing unit 16, a sound processing unit 17, a display unit 18, a sound output unit 19 and a communication unit 20.

The accepting unit 11 accepts a game operation of a user. For example, the accepting unit 11 accepts an operation to the operation buttons 2 of the controller 1. The game processing unit 9 performs a game process in accordance with the game processing program. The game played in the embodiment may be a game played by a single user by himself/herself, or a communication game played with another user who is connected by a network.

The photographing unit 12 photographs a specific object using the infrared camera 34. The storage unit 13 stores a parameter table 131 and a game processing program 132. The parameter table 131 stores parameters regarding the game in association with a plurality of shapes of the object and a plurality of brightness's, respectively.

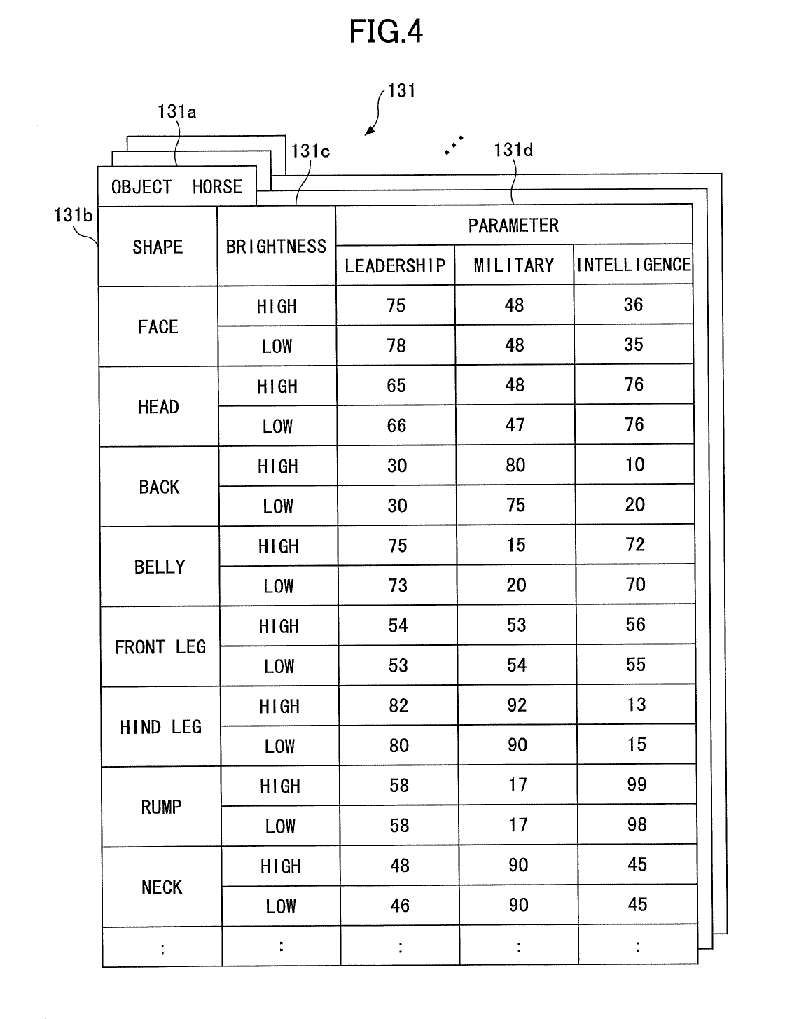

FIG. 4 illustrates an example of the parameter table 131 of the embodiment. In the parameter table 131 of FIG. 4, an object 131a is a “horse”, and a parameter 131d is in association with each of a plurality of shapes 131b of the horse and a plurality of brightness's 131c. Here, as the shapes 131b of the horse as the object, “face”, “head”, “back”, “belly”, “front leg”, “hind leg”, “rump”, “neck” and the like are stored. Further, different parameters 131d are stored for cases when the brightness 131c is “high” and “low” for each of the shapes. The parameter table 131 of FIG. 4 is a parameter for generating a military commander character, and the parameter 131d includes values of leadership, military and intelligence.

Referring back to FIG. 3, the specifying unit 14 specifies a parameter regarding the game based on at least either of a shape and brightness of the photographed object OJ, by referring to the parameter table 131. For example, when the shape of the object OJ, which is the photographed horse, is “face” and the brightness is “high”, the specifying unit 14 specifies a parameter as leadership “75”, military “48” and intelligence “36”, by referring to the parameter table 131 of FIG. 4.

The shape or the brightness of the object changes depending on a photographing position of the object OJ. Further, the shape or the brightness of the object changes depending on a photographing angle of the object OJ. Thus, the parameter can be changed by changing the shape of the object OJ included in a photographed image or the brightness of the image based on a posture or a direction when the infrared camera 34 photographs the object OJ, or a distance between the infrared camera 34 and the object OJ.

Here, the object OJ is not limited to an animal. The object OJ may be a site of a human body, a site of an animal other than a human and may be a movable object, a static object. For example, the object OJ may be a site of a human body such as a hand, a leg, a mouth or the like of a human, or a site such as a leg, a tail or the like of an animal such as a pet. Further, the object OJ may be a static object such as a figure of a character that appears in a game, or a movable object such as a robot. The object OJ may be a two-dimensional object, or a three-dimensional object. Here, it is preferable that the object OJ is a hand of a human because by setting a parameter that matches a concept imaged from a shape of a hand in the parameter table 131, foreseeability of the parameter specified by the shape of the hand can be increased.

Further, when generating a military commander character based on the specified parameter, it is preferable that the parameter in the parameter table 131 includes “leadership”, “military” and “intelligence” as illustrated in FIG. 4, however, this is not limited so. As another example of the parameter, levels of HP (hit points) of offense or defense used in a game, a degree of brightness of a background reflected in a game, a sign usable in a game, a tool or the like may be exemplified.

When a user photographs an object using the infrared camera 34, the display unit 18 displays a parameter specified based on the shape or the brightness of the object in real time.

In this embodiment, “photograph an image” includes a case when an image of the object is obtained by the infrared camera 34 when the infrared camera 34 is just directed to the object before the shutter button 34a is pressed, in addition to a case when an image of the object is obtained when the shutter button 34a is pressed.

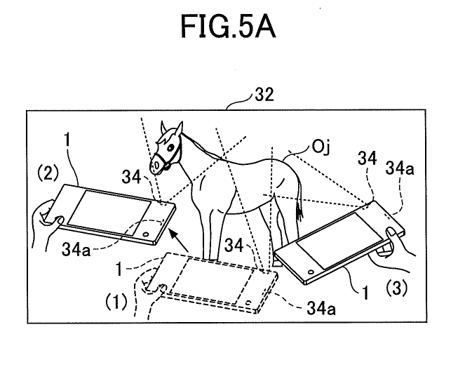

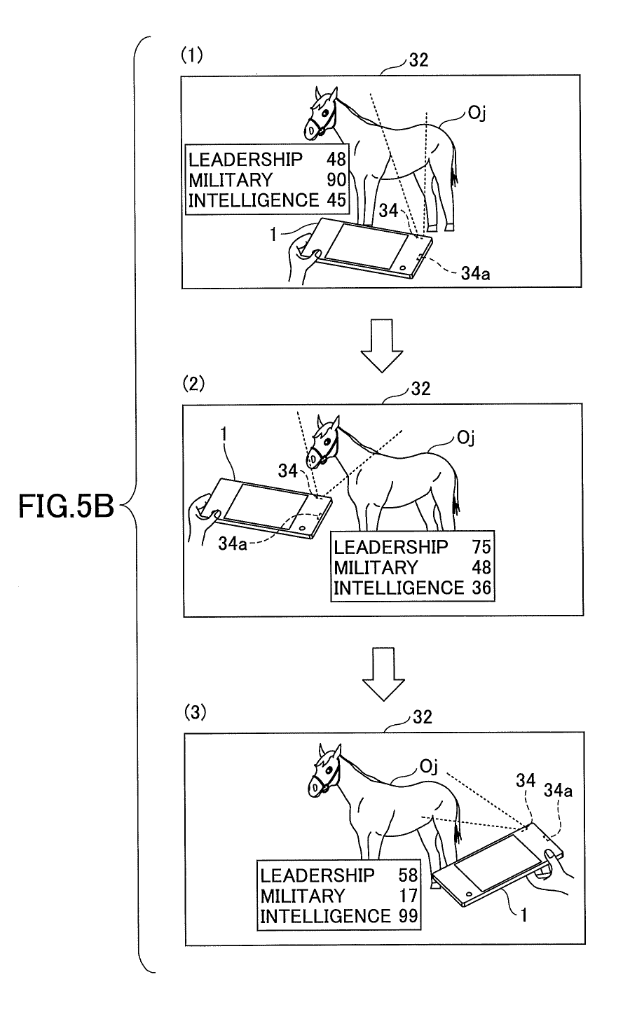

For example, a case of setting a parameter when a figure of a three dimensional horse is the object OJ is described. FIG. 5A is a view illustrating a state in which the infrared camera 34 is directed to the object OJ. FIG. 5B is a view illustrating an example of a display of the embodiment in which the specified parameter is displayed.

As illustrated in FIG. 5, the user photographs the object OJ using the infrared camera 34 provided in the controller 1, from different positions in different directions such as front, back, oblique and lateral directions.

First, for example, it is assumed that the user photographs the object OJ using the infrared camera 34 at a position (1) in FIG. 5A from a front and right side of the object OJ. At this time, by referring to the parameter table 131, the specifying unit 14 analyzes a shape and brightness of the object OJ from the photographed image of the object OJ. Alternatively, at this time, only the shape of the object OJ included in the image may be analyzed, or only the brightness of the object OJ included in the image may be analyzed.

At this time, if it is analyzed that the shape of the object OJ is “neck” and the brightness is “high”, by referring to the parameter table 131, the specifying unit 14 specifies the parameter 131d of leadership “48”, military “90” and intelligence “45”, which is in association with the shape 131b of “neck” and the brightness 131c of “high” (see FIG. 4). As a result, as illustrated in (1) of FIG. 5B, the display unit 18 displays the specified parameter of leadership “48”, military “90” and intelligence “45” on the display 32. Although the object OJ and the like are displayed with the parameter in (1) of FIG. 5B, alternatively, only the parameter may be displayed.

Subsequently, for example, it is assumed that the user photographs the object OJ using the infrared camera 34 at a position (2) in FIG. 5A from a front side of the object OJ. At this time, by referring to the parameter table 131, the specifying unit 14 analyzes a shape and brightness of the object OJ from the photographed image of the object OJ.

At this time, if it is analyzed that the shape of the object OJ is “face” and the brightness is “high”, by referring to the parameter table 131, the specifying unit 14 specifies the parameter 131d of leadership “75”, military “48” and intelligence “36”, which is in association with the shape 131b of “face” and the brightness 131c of “high” (see FIG. 4). As a result, the display unit 18 changes the display as illustrated in (2) of FIG. 5B, in which the parameter of leadership “75”, military “48” and intelligence “36” is displayed, from the parameter illustrated in (1) of FIG. 5B in real time.

Subsequently, for example, it is assumed that the user photographs the object OJ using the infrared camera 34 at a position (3) in FIG. 5A from a back side of the object OJ. At this time, by referring to the parameter table 131, the specifying unit 14 analyzes a shape and brightness of the object OJ from the photographed image of the object OJ.

At this time, if it is analyzed that the shape of the object OJ is “rump” and the brightness is “high”, by referring to the parameter table 131, the specifying unit 14 specifies the parameter 131d of leadership “58”, military “17” and intelligence “99”, which is in association with the shape 131b of “rump” and the brightness 131c of “high” (see FIG. 4). As a result, the display unit 18 changes the display as illustrated in (3) of FIG. 5B, in which the parameter of leadership “58”, military “17” and intelligence “99” is displayed, from the parameter illustrated in (2) of FIG. 5B in real time.

The processes described above with reference to FIG. 5A and FIG. 5B, the parameter may be specified every time the user directs the infrared camera 34 to the object OJ and the infrared camera 34 forms an image of the object OJ. The user moves the infrared camera 34 while confirming the displayed parameter, and presses the shutter button 34a when a desired parameter is displayed. With this, the parameter at the time when the shutter button 34a is pressed is selected.

Referring back to FIG. 3, the generating unit 15 generates a military commander character based on the selected parameter of the military commander character. For example, if the shutter button 34a is pressed when the display illustrated in (1) of FIG. 5B is displayed, the generating unit 15 generates a military commander character having the parameter of leadership “48”, military “90” and intelligence “45”, which means that the character is good at military.

Meanwhile, if the shutter button 34a is pressed when the parameter of (2) of FIG. 5B is displayed, the generating unit 15 generates a military commander character having the parameter of leadership “75”, military “48” and intelligence “36”, which means that the character is good at leadership.

Further, if the shutter button 34a is pressed when the parameter of (3) of FIG. 5B is displayed, the generating unit 15 generates a military commander character having the parameter of leadership “58”, military “17” and intelligence “99”, which means that the character is good at intelligence.

The graphics processing unit 16 is connected to the display unit 18, and outputs a video signal to the display unit 18 when a rendering instruction is output from the game processing unit 9. With this, the display unit 18 displays an image of the game in accordance with progression of the game.

The sound processing unit 17 is connected to the sound output unit 19, and outputs a sound signal to the sound output unit 19 when an instruction to output sound is output from the game processing unit 9. With this, the sound output unit 19 outputs a voice or sound in accordance with progression of the game. The communication unit 20 communicates with another device.

The function of the storage unit 13 is actualized by the ROM 22, the RAM 23 or the HDD 24 illustrated in FIG. 2, or a memory device or the like on a cloud connected to the game device 10 via a network, for example. The function of the accepting unit 11 is actualized by the input I/F 28 or the external I/F 26, for example. The function of the photographing unit 12 is actualized by the infrared camera 34, for example.

The functions of the game processing unit 9, the specifying unit 14, the generating unit 15 and the sound processing unit 17 are actualized by processes executed by the CPU 21 by the game processing program 132, for example.

The function of the graphics processing unit 16 is actualized by the graphics card 25, for example. The function of the display unit 18 is actualized by the display 32, for example. The function of the sound output unit 19 is actualized by the speaker 33, for example.

The function of the communication unit 20 is actualized by the communication I/F 27, for example. For example, when the parameter table 131 is stored in a memory device on a cloud, the communication unit 20 receives necessary data from the memory device on the cloud.

Here, FIG. 3 is a block diagram illustrating functions of the game device 10, and these functions illustrated by functional blocks may be actualized only by hardware, only by software, or by a combination of hardware and software.

The individual constituents of the game device 10 may be embodied by arbitrary combinations of hardware and software, typified by a CPU of an arbitrary computer, a memory, a program loaded in the memory so as to embody the constituents illustrated in the drawings, a storage unit for storing the program such as a hard disk, and an interface for network connection. It may be understood by those skilled in the art that methods and devices for the embodiment allow various modifications.

### Setting Parameter of Military Commander Character/Game Process

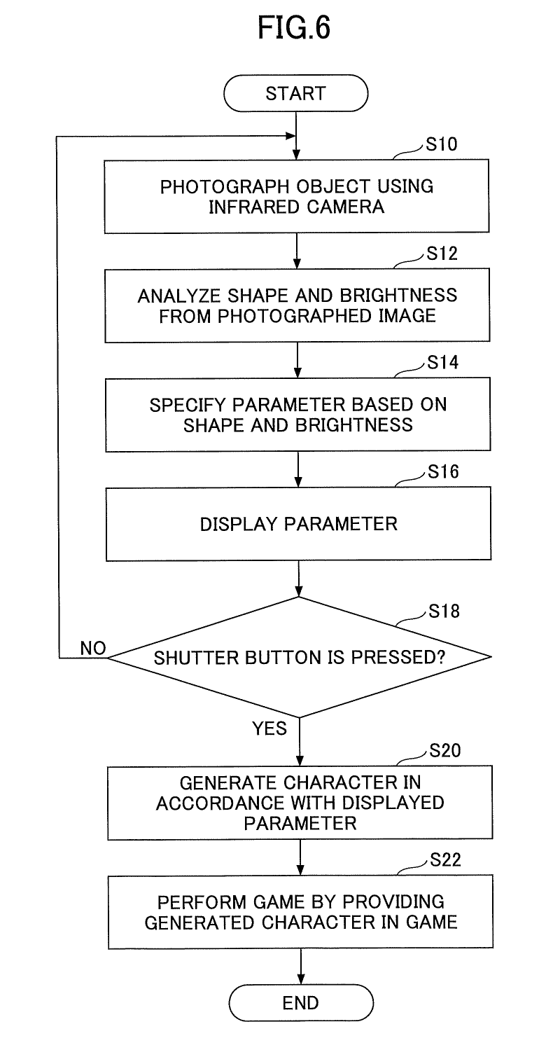

Next, an example of setting a parameter of a military commander character and a game process of the embodiment is described with reference to FIG. 6. FIG. 6 is a flowchart illustrating an example of a setting of a parameter and a game process of the embodiment.

When the user directs the infrared camera 34 to the object OJ, and an infrared ray is irradiated on the object OJ, the photographing unit 12 photographs the object OJ by receiving light reflected by the object OJ at an irradiated angle and at an irradiated position of the infrared ray, by the light receiving elements (step S10). Next, the specifying unit 14 analyzes a shape and brightness of the object OJ from the photographed image of the object OJ (step S12). Next, the specifying unit 14 specifies a parameter based on the shape and the brightness (step S14). At this time, the specifying unit 14 specifies a parameter that is in association with the shape and the brightness of the object OJ analyzed from the photographed image, by referring to the parameter table 131.

Next, the display unit 18 displays the specified parameter (step S16). Next, the generating unit 15 determines whether the shutter button 34a is pressed (step S18). When the shutter button 34a is not pressed by the user, the generating unit 15 determines that the shutter button 34a is not pressed (NO in step S18), and returns to step S10.

The photographing unit 12 photographs the object OJ again at a position and an angle directed by the infrared camera 34 at this time (step S10). Next, the specifying unit 14 analyzes a shape and brightness of the object OJ from the photographed image of the object OJ this time (step S12), and specifies the parameter corresponding to the shape and the brightness (step S14). Next, the display unit 18 displays the specified parameter (step S16). As such, the user can confirm values of the parameter that are changed by changing a position or an angle of the object OJ directed by the infrared camera 34, and can press the shutter button 34a when a desired parameter adaptable to a military commander character is displayed, for which the user want to generate.

The generating unit 15 determines whether the shutter button 34a is pressed (step S18), and processes of step S10 to step S18 are repeated until the shutter button 34a is pressed. When the shutter button 34a is pressed (YES in step S18), the generating unit 15 generates a military commander character in accordance with the displayed parameter (step S20).

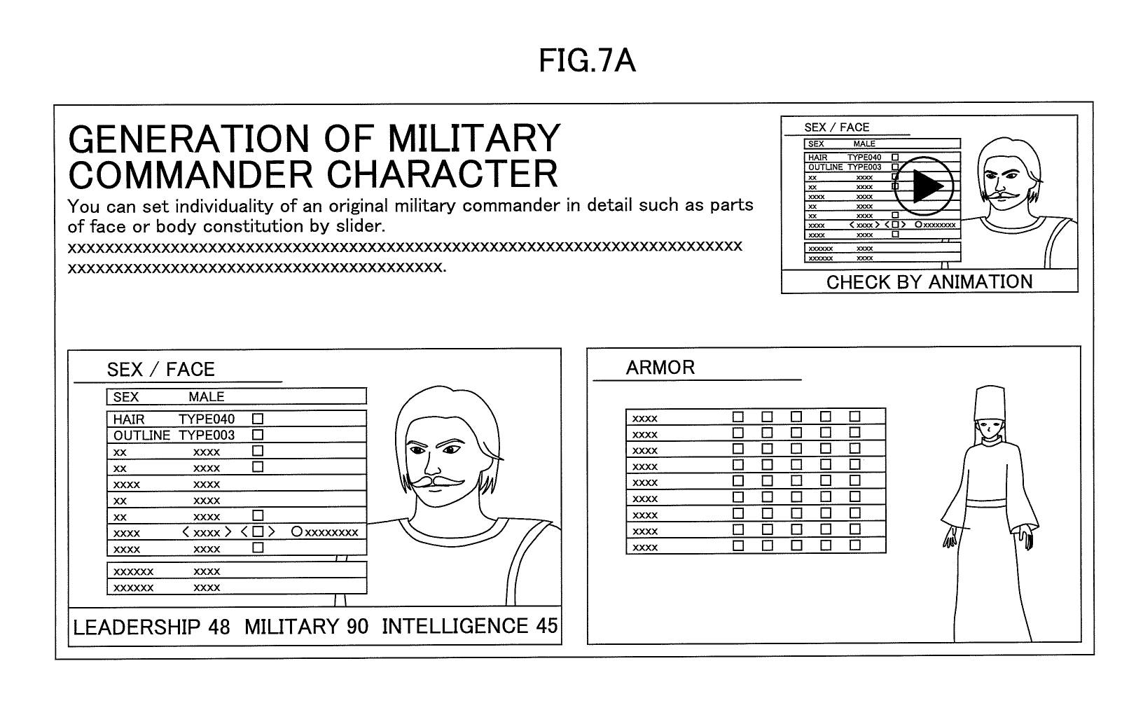

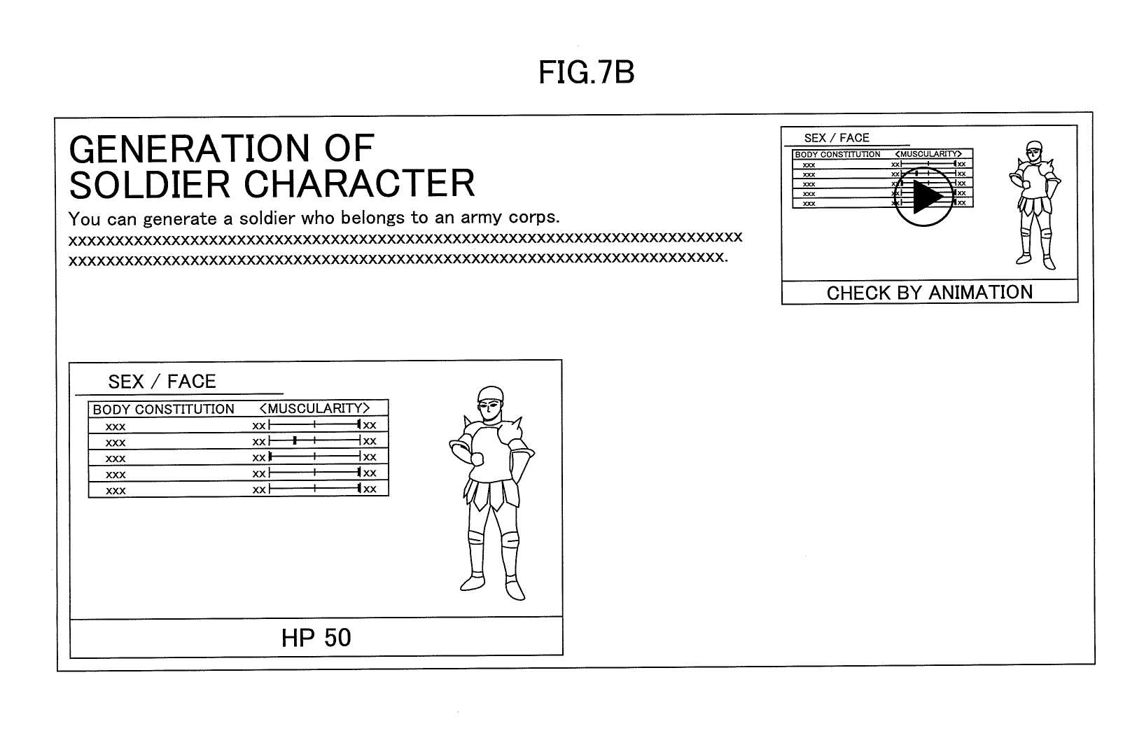

FIG. 7A illustrates an example of a military commander character generation screen. Here, the parameter regarding the leadership, the military and the intelligence of the military commander character is already determined. In addition, as illustrated in FIG. 7A as an example, the user can select a preferable pattern from a plurality of prepared patterns for each of sexuality, hair, an outline, eyebrows, armor and the like of the military commander character in the military commander character generation screen. At this time, the user can select the preferable pattern by confirming a composite image of the military commander character to be formed, as illustrated at a right side in FIG. 7A.

Here, when generating a character, not only the leadership, the military and the intelligence of the military commander character illustrated in FIG. 7A, parameters indicating other characteristics of the military commander character may be set by photographing the object OJ by the infrared camera 34. Further, as illustrated in FIG. 7B, not only the military commander character, but HP, a guard, color or the like of a soldier character who belongs to an army corps may be set by photographing the object OJ by the infrared camera 34.

Referring back to FIG. 6, the game processing unit 9 performs a desired game by providing the generated character in the game (step S22), and this process is finished.

As described above, according to the embodiment, when the user changes a posture or a position of the infrared camera 34, or a distance between the infrared camera 34 and the object OJ, a parameter that is in association with a shape and brightness of the object OJ to be photographed can be displayed in real time. Then, by pressing the shutter button 34a when a preferable parameter adapted to a desired military commander character to be generated is displayed, the user can generate a military commander character with a desired parameter. In particular, according to the embodiment, by irradiating an infrared ray from the infrared camera 34 in different directions or at different positions to one object OJ, the user can generate a military commander character with various parameters. As a result, the user can set one of the parameters capable of being specified by photographing the object by various shapes or the brightness's.

### Another Example of Setting Parameter of Military Commander Character

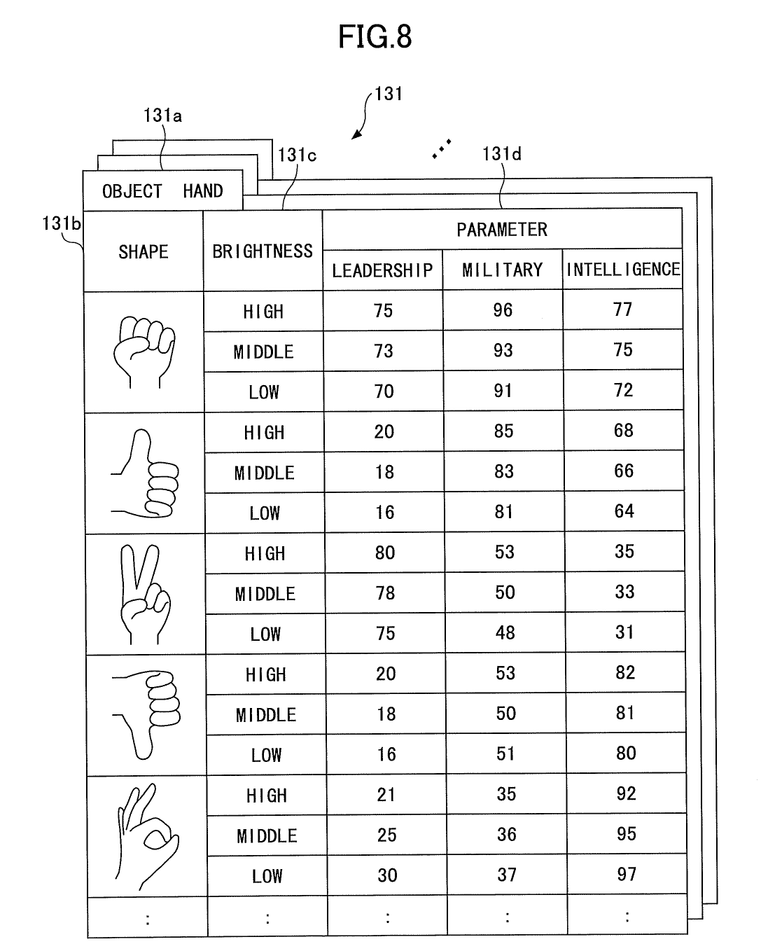

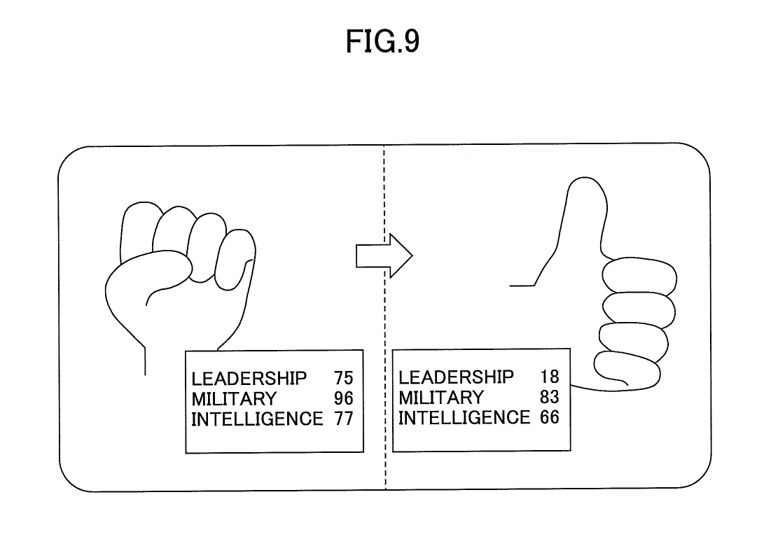

Next, another example of setting a parameter of the military commander character and a game process of the embodiment is described. FIG. 8 illustrates another example of the parameter table 131 of the embodiment. FIG. 9 is a view illustrating another example of a display of the embodiment in which a parameter is displayed.

In the parameter table 131 of FIG. 8, an object 131a is a “hand”, and a parameter 131d is in association with each of a plurality of shapes 131b and a plurality of brightness's 131c. Here, as the shape 131b of the hand as the object, a “rock” hand, a “thumbs-up” hand, a “scissors” hand (peace sign), a “thumbs-down” hand, a “make a circle with his/her index finger and thumb” hand and the like are stored. Further, different parameters 131d are stored for cases when the brightness 131c is “high”, “middle” and “low” for each of the shapes.

Referring to FIG. 3 as well, the specifying unit 14 specifies a parameter regarding the game based on at least either of a shape and brightness of the hand, which is the photographed object OJ, by referring to the parameter table 131. For example, when the user changes his/her hand photographed by the infrared camera 34 to “rock”, the specifying unit 14 specifies the parameter 131d that is in association with the shape of “rock” and the brightness of “high”, by referring to the parameter table 131 of FIG. 8. As a result, a parameter of the leadership “75”, the military “96” and the intelligence “77” is specified. Then, the display unit 18 displays the specified parameter of leadership “75”, military “96” and intelligence “77”, as illustrated at a left side of FIG. 9.

Thereafter, when the user changes his/her hand, photographed by the infrared camera 34, to “thumbs-up”, the specifying unit 14 specifies the parameter 131d that is in association with the shape of “thumbs-up” and the brightness of “middle”, by referring to the parameter table 131. As a result, a parameter of the leadership “18”, the military “83” and the intelligence “66” is specified. Then, the display unit 18 changes the parameter of leadership “18”, military “83” and intelligence “66” to be displayed in real time, as illustrated at a right side of FIG. 9.

Setting a parameter and a game process of the embodiment using the parameter table 131 of FIG. 8 and using the hand of the user as the object OJ are the same as those described above with reference to the flowchart illustrated in FIG. 6, and the description is not repeated.

As described above, in this embodiment, by changing the shape or the angle of the hand to be photographed by the infrared camera 34, the user can confirm values of the parameter that are changed, and press the shutter button 34a when a preferable parameter adapted to a desired military commander character to be generated is displayed. As such, the user can generate the military commander character by the specified parameter. In particular, in this embodiment, by changing one hand in various shapes, the user can display a plurality of parameters for the military commander character in accordance with the shape or the brightness of the hand photographed by the infrared camera 34. With this, the user can select a desired parameter from the displayed parameters to generate the military commander character. As such, the user can set the parameter by selecting from the different parameters specified for one object.

In particular, when the object OJ is a hand of a human, by setting a parameter that matches a concept imaged from a shape of a hand in the parameter table 131, foreseeability of the parameter specified by the shape of the hand can be increased.

For example, there is a concept that fortunes are more risen at the “thumbs-up” hand than at the “thumbs-down”, thus, a parameter with better values may be set in association with the “thumbs-up” hand in the parameter table 131.

### Applied Example 1 of Game Process

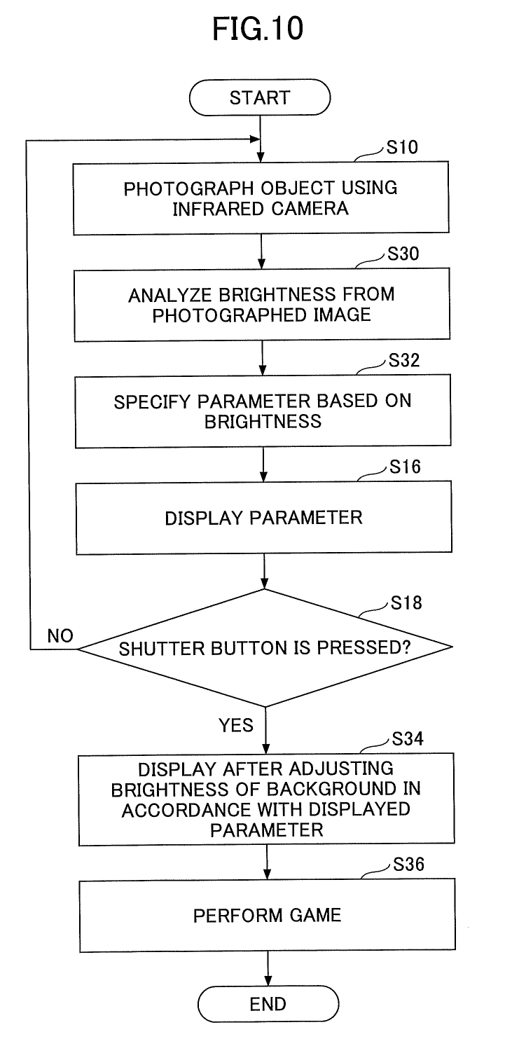

Hereinafter, an applied example 1 of the game process of the embodiment is described with reference to FIG. 10. FIG. 10 is a flowchart illustrating the game process of the applied example 1 of the embodiment. Here, an example is described in which the parameter is “a degree of brightness of a background reflected in a game”, and the parameter is specified only based on brightness of a photographed image of the object OJ. Thus, a plurality of the brightness's of the object OJ and a plurality of the parameters are in association with each other, respectively, in the parameter table.

When a user directs the infrared camera 34 to the object OJ, and an infrared ray is irradiated on the object OJ, the photographing unit 12 photographs the object OJ by receiving light reflected by the object OJ at an irradiated angle and at an irradiated position of the infrared ray, by the light receiving elements (step S10). Next, the specifying unit 14 analyzes brightness of the photographed image of the object OJ (step S30). Next, by referring to the parameter table in which the brightness's and the parameters are in association with each other, respectively, the specifying unit 14 specifies a parameter that is in association with the analyzed brightness (step S32).

Next, the display unit 18 displays the specified parameter (step S16). Next, the generating unit 15 determines whether the shutter button 34a is pressed (step S18). When the shutter button 34a is not pressed by the user (NO in step S18), the process returns back to step S10, and the processes after step S10 are repeated.

By changing the position or the angle of the object OJ to which the infrared camera 34 is directed, the user can confirm changing values of the parameter and press the shutter button 34a at an appropriate timing.

When the shutter button 34a is pressed (YES in step 18), the generating unit 15 adjusts brightness of a background of the game corresponding to the displayed parameter, and the display unit 18 displays the game with the adjusted background (step S34). The game processing unit 9 performs a desired game by rendering a background at a time zone desired by the user (step S22), and this process is finished.

For example, it is assumed that the object OJ is photographed while the infrared camera 34 is covered by a hand of the user. At this time, the specifying unit 14 analyzes that the brightness of the photographed image is “low” from the photographed image of the object OJ, and by referring to the parameter table in which the brightness's and the parameters are in association with each other, respectively, specifies a parameter such as “darkening the background” that is in association with the analyzed brightness.

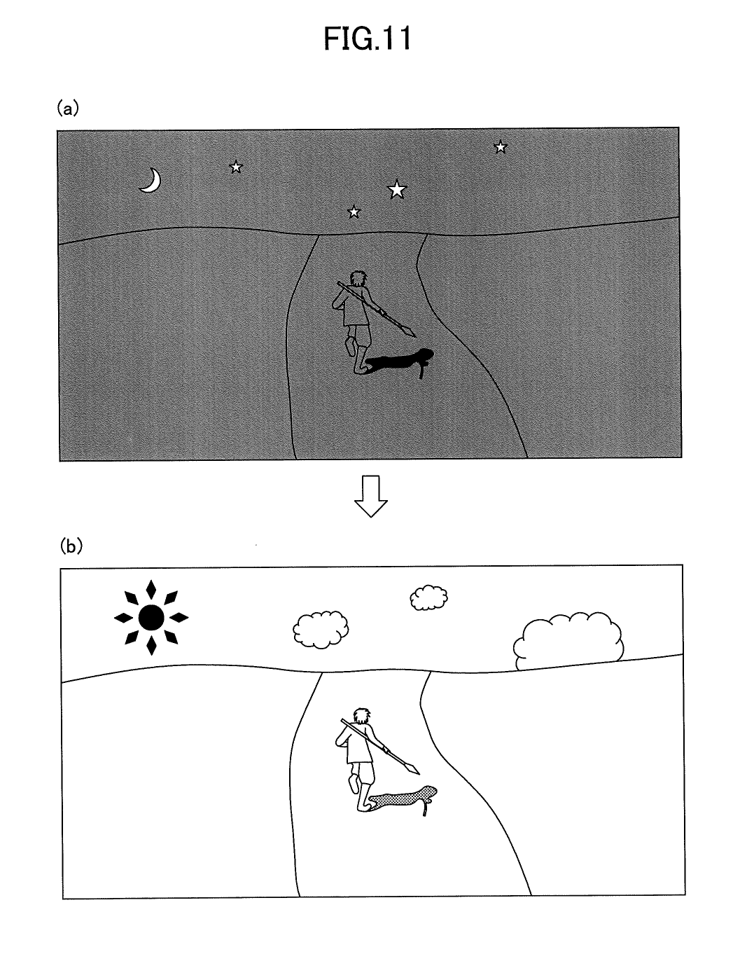

With this, as illustrated in (a) of FIG. 11, the background of the performed game becomes dark to express a night scene in one scene of the game. With this, atmosphere of the game can be changed. Further, a story of the game may be changed in accordance with the night scene to give a surprise to the user.

Further, for example, it is assumed that the object OJ is photographed after the hand of the user covering the infrared camera 34 is released from the infrared camera 34. At this time, the specifying unit 14 analyzes that the brightness of the photographed image is “high” from the photographed image of the object OJ, and by referring to the parameter table in which the brightness's and the parameters are in association with each other, respectively, specifies a parameter such as “brightening the background” that is in association with the analyzed brightness.

With this, as illustrated in (b) of FIG. 11, the background of the performed game becomes bright to express a day scene in one scene of the game. With this, atmosphere of the game can be changed. A story of the game may be changed in accordance with the day scene.

As described above, according to the applied example 1 of the embodiment, brightness's of photographed images can be changed by covering the infrared camera 34 by the hand, or releasing the hand from the infrared camera 34. Then, the background of the game can be changed based on the parameter that is changed in accordance with the change of brightness of the photographed image.

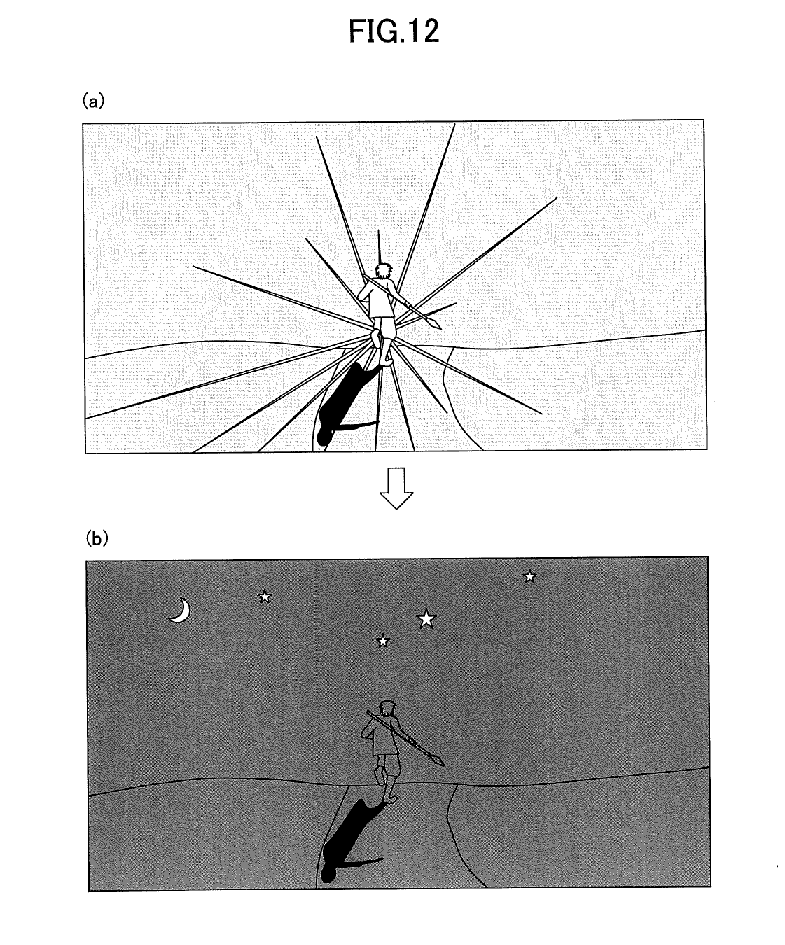

Further, in this example, the parameter may further include information regarding a type of a scene in the game such as a battle scene or a rest time scene in addition to the degree of brightness of the background reflected in the game. For example, when the user photographs the object OJ under a state that the hand is released from the infrared camera 34, a battle scene in daytime as illustrated in (a) of FIG. 12 may be displayed. Meanwhile, when the user photographs the object OJ under a state that the infrared camera 34 is covered by the hand, a rest time between battles at night as illustrated in (b) of FIG. 12 may be displayed.

Further, the parameter may be a color of offense or a display range of the offense, and the color of offense or the display range of the offense may be changed based on the difference in brightness of the image photographed by the infrared camera 34 under the state when the infrared camera 34 is covered by the hand and under the state when the hand is released.

### Applied Example 2 of Game Process

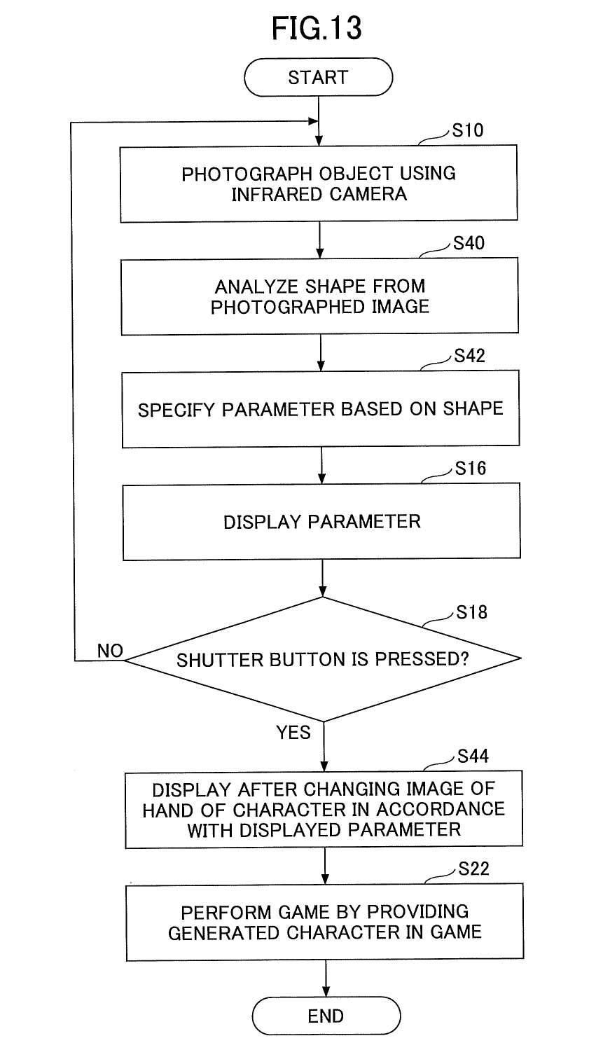

Next, an applied example 2 of the game process of the embodiment is described with reference to FIG. 13. FIG. 13 is a flowchart illustrating the game process of the applied example 2 of the embodiment. Here, an example is described in which the parameter is “a shape of an image displayed in a game scene”, and the parameter is specified only based on a shape of the object OJ in a photographed image of the object OJ. Thus, a plurality of the shapes of the object OJ and a plurality of the parameters are in association with each other, respectively, in the parameter table.

When a user directs the infrared camera 34 to the object OJ, and an infrared ray is irradiated on the object OJ, the photographing unit 12 photographs the object OJ by receiving light reflected by the object OJ at an irradiated angle and at an irradiated position of the infrared ray, by the light receiving elements (step S10). Next, the specifying unit 14 analyzes a shape of the object OJ such as a hand from the photographed image of the object OJ (step S40). Next, by referring to the parameter table in which the shapes and the parameters are in association with each other, respectively, the specifying unit 14 specifies a parameter that is in association with the analyzed shape (step S42).

Next, the display unit 18 displays the specified parameter (step S16). Next, the generating unit 15 determines whether the shutter button 34a is pressed (step S18). When the shutter button 34a is not pressed by the user (NO in step S18), the process returns back to step S10, and the processes after step S10 are repeated.

By changing the position or the angle of the hand, which is the object OJ, to which the infrared camera 34 is directed, the user can confirm changing values of the parameter (a shape of the hand (peace sign, for example) itself, a description of the shape of the hand or a digitized display of the shape of the hand). Then, the user can press the shutter button 34a when a desired parameter is displayed.

When the shutter button 34a is pressed (YES in step 18), the generating unit 15 obtains an image of a hand of a character corresponding to the displayed parameter, and the display unit 18 displays the obtained image of the hand by reflecting it in the game (step S44). The game processing unit 9 performs the game in which the image of the hand is reflected (step S22), and this process is finished.

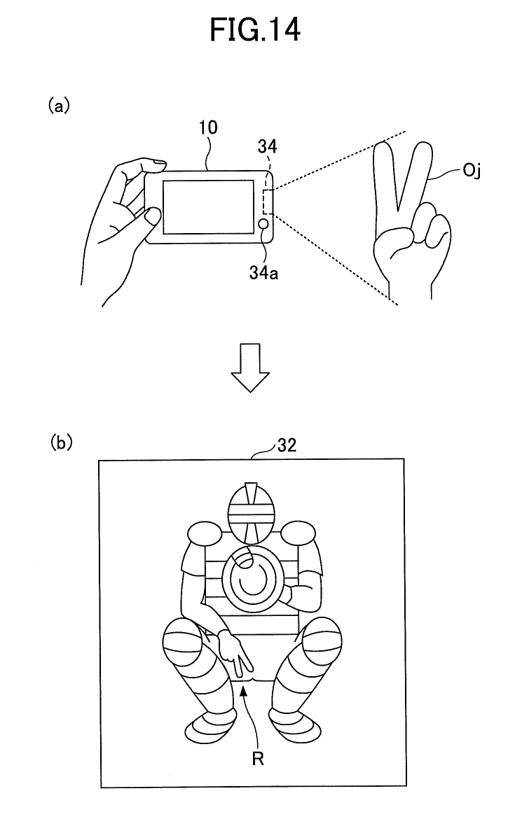

For example, it is assumed that an image of a hand of a user with a peace sign is formed by the infrared camera 34, as illustrated in (a) of FIG. 14. At this time, the specifying unit 14 analyzes that the shape is “a hand with a peace sign” from the photographed image of the object OJ, and by referring to the parameter table in which the shapes and the parameters are in association with each other, respectively, specifies a parameter that is in association with the analyzed shape such as “a peace sign of a catcher”.

With this, as illustrated in (b) of FIG. 14, a sign R of a catcher in a performed baseball game becomes a downward peace sign in one scene of the game. With this, the user can instruct a type of ball thrown by a pitcher in the baseball game. With this, it is possible to give a feeling as if the user is a catcher and can give an instruction to a pitcher.

### Applied Example 3 of Game Process

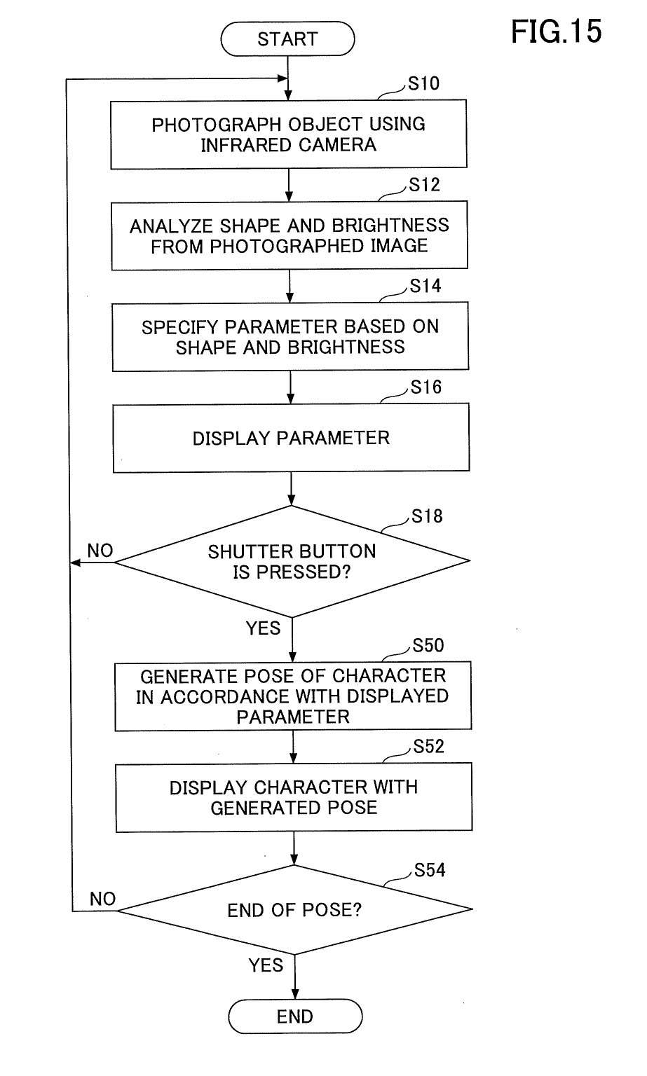

Next, an applied example 3 of the game process of the embodiment is described with reference to FIG. 15. FIG. 15 is a flowchart illustrating the game process of the applied example 3 of the embodiment. Here, an example is described in which the parameter is “a pose (movement) of a character that is provided in a game scene”.

In the following description, a game scene in which a character unsheathes a sword is described as an example. Here, a user can assume the controller 1 as a sheath, and takes a posture to unsheathe a sword from the sheath using the controller 1. When the user takes a posture to unsheathe a sword that is in a sheath, while assuming the controller 1 as the sheath, in a scene of a game, the photographing unit 12 photographs the posture, as the object OJ (step S10). Next, the specifying unit 14 analyzes a shape and brightness of the photographed image (step S12). Next, by referring to a parameter table in which shapes and brightness's are in association with the parameters, respectively, the specifying unit 14 specifies a parameter that is in association with the analyzed shape and the brightness (step S14). Here, alternatively, only the brightness of the photographed image may be analyzed, and the parameter may be specified from the analyzed brightness.

Next, the display unit 18 displays the specified parameter (step S16). Next, the generating unit 15 determines whether the shutter button 34a is pressed (step S18). When the shutter button 34a is not pressed by the user (NO in step S18), the process returns back to step S10, and the processes after step S10 are repeated.

On the other hand, when the shutter button 34a is pressed (YES in step S18), the generating unit 15 generates a posture of the character corresponding to the displayed parameter (step S50). The display unit 18 displays the character by the generated posture (step S52). The game processing unit 9 determines whether the posture is finished (step S54), and when it is determined to be finished (YES in step S54), the process is finished. On the other hand, when it is determined not to be finished (NO in step S18), the process returns back to step S10, and the processes after step S10 are repeated.

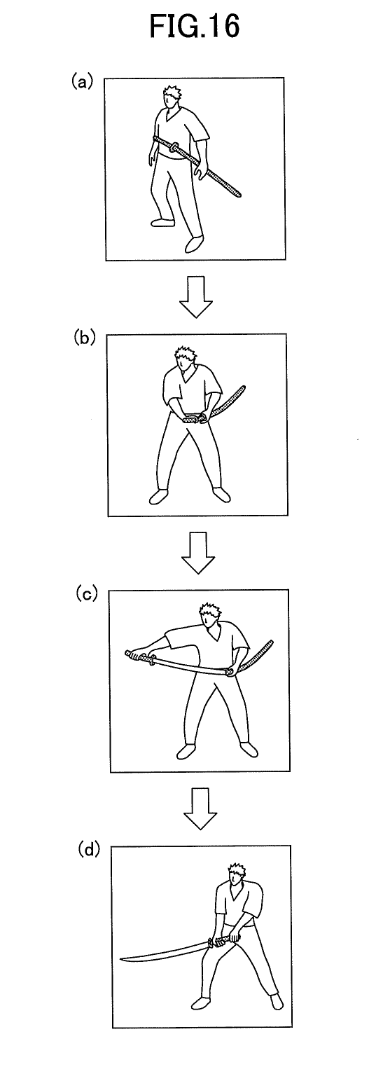

In FIG. 16, (a) illustrates a state of a character at a start of a game scene. Further, in this game, as described above, the controller 1 is used as the sheath by the user. Then, when the user wants to unsheathe a sword whose blade is inserted in the sheath, while assuming the controller 1 as the sheath, the user holds the controller 1 by his/her left hand, and places his/her right hand near the infrared camera 34. Thus, when the user takes the posture to unsheathe the sword whose blade is inserted in the sheath, while assuming the controller 1 as the sheath, the right hand of the user is placed near the infrared camera 34. With this, an image formed by the infrared camera 34 becomes a bit dark. Thus, by setting a posture as illustrated in (b) of FIG. 16 as a parameter corresponding to a case where the brightness of the image is bit dark, a scene in which a character takes a posture as illustrated in (b) of FIG. 16 can be expressed in one scene of the game.

When the user gradually releases the right hand from the controller 1 held by the left hand after the user takes the posture to unsheathe the sword whose blade is inserted in the sheath, while assuming the controller 1 as the sheath, brightness sensed by the infrared camera 34 is changed from dark to bright.

When the processes of steps S10 to S18, S50 and S52 are performed under this state, for example, as illustrated in (b) to (c) or (d) of FIG. 16, the displayed posture of the character is changed. In other words, when the user takes a posture to gradually unsheathing the blade of the sword from the sheath while assuming the controller 1 as the sheath, the image formed by the infrared camera 34 gradually becomes bright. Thus, by setting postures as illustrated in (c) and (d) of FIG. 16 as parameters corresponding to brightness's of the image becoming brighter, a scene of unsheathing the sword in which the posture of the character gradually changes from (c) to (d) of FIG. 16 can be expressed in one scene of the game. With this, it is possible to give a feeling to the user as if the user himself/herself is a knight and fights using the sword.

According to the recoding medium storing the game processing program and the data processing apparatus of the above described embodiments, the other examples, the applied example 1 to the applied example 3, a technique is provided enabling a user to select a preferable one from a plurality of different selections using one object.

Although a preferred embodiment of the recoding medium storing the game processing program and the data processing apparatus has been specifically illustrated and described, it is to be understood that minor modifications may be made therein without departing from the spirit and scope of the invention as defined by the claims.

The present invention is not limited to the specifically disclosed embodiments, and numerous variations and modifications may be made without departing from the spirit and scope of the present invention.

For example, although a case in which a military commander character is generated in a history simulation game is described in the above embodiments, generation of a character is not limited to the military commander. For example, by photographing a pet of a user, a parameter of a pet character that appears in a game may be specified in accordance with a photographed position or a photographed angle of the pet, brightness at the time of photographing or the like.

Further, a message may be set as a parameter in the parameter table 131. For example, a message such as “great !” may be set as the parameter in the parameter table 131 that is in association with a shape of a hand of a user “thumbs-up”.

What is claimed is:

1. A non-transitory computer-readable recording medium having recorded thereon a game processing program that causes a computer to execute a process comprising:
photographing an object using an infrared sensor; and
specifying a parameter regarding a game based on at least either of a shape and brightness of the photographed object, by referring to a storage unit in which at least either of a plurality of shapes of an object and a plurality of brightness's are in association with parameters regarding the game, respectively.

2. The non-transitory computer-readable recording medium according to claim 1,
wherein the parameter is specified based on at least either of a shape and brightness of the photographed object, when the object is photographed by changing at least either of an irradiation position and an irradiation direction of an infrared ray output from the infrared sensor to the object, and
wherein the specified parameter is displayed by being changed in accordance with changing at least either of the irradiation position and the irradiation direction of infrared ray to the object.

3. The non-transitory computer-readable recording medium according to claim 1, wherein the object is either of a site of a human body, a site of an animal other than a human, a movable object and a static object.

4. The non-transitory computer-readable recording medium according to claim 3, wherein the object is a hand of a human.

5. The non-transitory computer-readable recording medium according to claim 4, wherein the specified parameter is displayed by being changed in accordance with a change of at least either of a shape and brightness of the photographed hand due to a change of an operation of the hand of the human.

6. The non-transitory computer-readable recording medium according to claim 1, wherein the parameter is either of a parameter regarding a character of the game, a parameter regarding a scene of the game, a parameter regarding a message, a parameter regarding an instruction in the game and a parameter regarding a condition of the game.

7. A data processing apparatus comprising:
a photographing unit that photographs an object using an infrared sensor; and
a specifying unit that specifies a parameter regarding a game based on at least either of a shape and brightness of the photographed object, by referring to a storage unit in which at least either of a plurality of shapes of an object and a plurality of brightness's are in association with parameters regarding the game, respectively.
